(19) United States
(12) Patent Application Publication
(10) Pub. No.: US 2008/0128379 A1
(43) Pub. Date: Jun. 5, 2008

(54) Teat For An Infant Feeding Bottle

(76) Inventor: Gilad Hen, Haifa (IL)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/936,429

(22) Filed: Nov. 7, 2007

(30) Foreign Application Priority Data
Dec. 5, 2006 (IL) 179841

(51) Int. Cl. A61J 11/02; A61J 11/00

(52) U.S. Cl. 215/11.5; 215/11.1

(57) ABSTRACT

A one-way valve is illustrated that comprises a passageway in the feeding bottle of a baby or infant and a relatively flexible wall that is installed adjacently to the passageway so as to cover the passage. The passageway and the flexible wall establish a one-way valve that alternates between a state in which there is aerodynamic communication between the exterior and the interior of the feeding bottle and a state in which the aerodynamic communication is prevented. The one-way valve equalizes the pressures and facilitates the sucking action of the baby or infant.

### FIELD OF THE INVENTION

The present invention relates to infant feeding bottles. More particularly, the present invention relates to a teat having a one way valve for improving feeding infants through a bottle.

This present invention claims the benefit of earlier IL patent application S.N. 179841 filed on 5 of Dec. 2006 by Hen Gilad and entitled “One-way valve for entrance of air, for feeding bottles of babies, that are built perforates and inner coverage”.

### BACKGROUND OF THE INVENTION

Bottles for feeding babies are a widespread product that substantially preserves its shape and characteristics since it was developed. Over the years, it has been shown that the massive use of feeding bottles by babies result in problems such as ear aches, ear infections, swallowing air, and slow feeding.

As a consequence, attempts were made in the recent years to develop bottles as well as teats that will partially or totally solve the problem. Some of the solutions involve the bottle itself. Most of the solutions deal with a one-way valve that is usually provided in the bottom portion of the bottle. An example is disclosed in GB patent no. 2350096 that describes a bottle that comprises a one-way valve located at the end of the bottle remote from the cap that has an inlet side one the exterior of the bottle wall and an outlet sode in the interior of the bottle wall for admitting ambient atmosphere into the interior of the bottle. This allows compensation for the relative low pressure formed as liquid is sucked from the bottle and facilitates sucking liquid out of the bottle. This group of patents includes also U.S. Pat. No. 5,699,921; WO 2006103658; GB 2323838; U.S. Pat. No. 4,401,224.

This group of patents usually comprised of a valve that is not an integrated part of the bottle and is adapted to be screwed into the bottle. This solution is cumbersome and significantly increases the cost of producing such a bottle.

There are some solutions to the problem. One of the solutions is presented in a website http://www.babybfree.com illustrating several tubes adapted to allow air passage that are provided beneath the teat. This type of mechanism is highly complicated and also increases the cost of the teat. Moreover, food is allowed to be discharged through those tubes. Other valves in the teat are disclosed in GB 2250017 and GB 2412114. These valves are relatively complicated; therefore, increase the cost of the teat substantially.

There is a substantial need to provide a one-way valve that is simple to manufacture so as avoid massive increase in the feeding bottle costs as well as a valve that will not suffer from disadvantages that were shown herein before in the available teat. Moreover, the need is to present a solution in the teat itself that will avoid additional bottles and will fit to every standard bottle. Moreover, it is easy to clean.

### SUMMARY OF THE INVENTION

It is an object of the present invention to provide a one-way valve to an infant feeding bottle that is simple to manufacture and effective in compensating the low pressure that is developed within the bottle when the food is sucked out of it.

It is another object of the present invention to provide a one-way valve in the teat of an infant feeding bottle that is easy to clean and maintain.

It is yet another object of the present invention to provide a simple one-way valve that prevents food from being discharged through it.

It is provided in accordance with a preferred embodiment of the present invention a one-way valve for an infant feeding bottle having a teat and a bottle's body comprising:

At least one passageway aerodynamically communicating an interior of the feeding bottle and its exterior;

At least one member adapted to cover said at least one passageway wherein said at least one member is adapted to have a first position in which the member is fully adjacent to the passageway preventing the aerodynamic communication through the passageway and a second position in which the member is slightly removed of the passageway allowing air to pass through said at least one passageway;

whereby when ambient pressure is higher than the pressure within the feeding bottle, the member is in its second position allowing passage of air through the passageway into the feeding bottle.

Furthermore in accordance with another preferred embodiment of the present invention, said at least one passageway is provided in the feeding bottle.

Furthermore in accordance with another preferred embodiment of the present invention, said at least one member is a circumferential ring adapted to fit an inner circumference of the feeding bottle in a vicinity of the passageway.

Furthermore in accordance with another preferred embodiment of the present invention, said at least one passageway is provided in the teat.

Furthermore in accordance with another preferred embodiment of the present invention, said at least one passageway is provided in the bottle's body.

Furthermore in accordance with another preferred embodiment of the present invention, said circumferential ring is held in place by a lateral base adapted to be pressed between the teat and the bottle's body.

Furthermore in accordance with another preferred embodiment of the present invention, said lateral base is incorporated within the teat.

Furthermore in accordance with another preferred embodiment of the present invention, said member is a flat member having protrusions designed to be inserted and maintained within respective holes in the teat.

Furthermore in accordance with another preferred embodiment of the present invention, at least one member is a flat member having protrusions designed to be inserted and maintained within respective holes in the bottle's body.

Furthermore in accordance with another preferred embodiment of the present invention, said member is a flat member soldered adjacent to said at least one passageway.

Furthermore in accordance with another preferred embodiment of the present invention, said member is a circumferential ring adapted to accord an inner circumference of the feeding bottle and wherein said passageway is provided in said circumferential ring.

Furthermore in accordance with another preferred embodiment of the present invention, said circumferential ring is provided with a lateral base in which said at least one passageway is provided and wherein said lateral base is adjacent to a lateral base of the teat.

Furthermore in accordance with another preferred embodiment of the present invention, said circumferential ring fits inner circumference of the teat.

Furthermore in accordance with another preferred embodiment of the present invention, said circumferential ring accord inner circumference of a neck area in the bottle's body.

Furthermore in accordance with another preferred embodiment of the present invention, said circumferential ring comprises an upper wall provided on one side of said lateral base and a bottom wall provided on the other side of said lateral base and wherein said upper wall accord inner circumference of the teat and said bottom wall accord inner circumference of a neck area in the bottle's body.

It is further provided in accordance with another preferred embodiment of the present invention, a method of forming a one-way valve in a feeding bottle comprising a teat and a bottle's body comprising:

providing at least one member capable of adjacently hold on an inner surface in the feeding bottle;

forming at least one passageway aerodynamically communicating an interior of the feeding bottle and its exterior;

placing said at least one member within the feeding bottle adjacent to said at least one passageway so that the passageway is regularly blocked and is allowing air flow when ambient pressure in the exterior of the feeding bottle exceeds pressure within the feeding bottle.

Furthermore in accordance with another preferred embodiment of the present invention, said at least one passageway is in the teat.

Furthermore in accordance with another preferred embodiment of the present invention, said at least one passageway is in the bottle's body.

Furthermore in accordance with another preferred embodiment of the present invention, said member is a circumferential ring capable of fitting an inner circumference of the feeding bottle.

Furthermore in accordance with another preferred embodiment of the present invention, said circumferential ring is provided with a lateral base adapted to be held between the teat and the bottle's body so as to maintain the ring in place.

Furthermore in accordance with another preferred embodiment of the present invention, said at least one member is a flat member soldered to the feeding bottle in the vicinity of said the passageway.

Furthermore in accordance with another preferred embodiment of the present invention, said at least one member is held adjacent to said the passageway by protrusions that are inserted in dedicated bores in the feeding bottle.

There is another preferred embodiment providing a method of forming a one-way valve in a feeding bottle comprising a teat and a bottle's body comprising:

providing at least one member having a passageway;

placing the member so that an interior of the feeding bottle is aerodynamically communicating with its exterior wherein the passageway is regularly blocked by the feeding bottle and allows air flow when ambient pressure outside the feeding bottle exceeds pressure within the feeding bottle.

Additionally in accordance with another preferred embodiment of the present invention, said at least one member is a circumferential ring having a lateral base designed to sit between the teat and the bottle's body and wherein said passageway is provided in said lateral base.

### BRIEF DESCRIPTION OF THE FIGURES

In order to better understand the present invention and appreciate its practical applications, the following Figures are attached and references herein. Like components are denoted by like reference numerals.

It should be noted that the figures are given as examples and preferred embodiments only and in no way limit the scope of the present invention as defined in the appending Description and Claims.

FIG. 1 illustrates different views of a teat provided with a through hole in accordance with a preferred embodiment of the present invention.

FIG. 2 illustrates different views of an inner ring in accordance with a preferred embodiment of the present invention, for installing internally to the teat shown in FIG. 1.

FIG. 3 illustrates different views of a one-way valve in a teat in accordance with a preferred embodiment of the present invention.

FIG. 4 illustrates the one-way valve shown in FIG. 3 in action.

FIG. 5 illustrates different views of a one-way valve in a teat in accordance with another preferred embodiment of the present invention.

FIG. 6 illustrates the one-way valve shown in FIG. 5 in action.

FIG. 7 illustrates different views of a teat provided with a through hole and two bores in accordance with a preferred embodiment of the present invention.

FIG. 8 illustrates different views of an inner hole coverage in accordance with a preferred embodiment of the present invention, for installing internally to the teat shown in FIG. 7.

FIG. 9 illustrates different views of a one-way valve in a teat in accordance with yet another preferred embodiment of the present invention.

FIG. 10 illustrates the one-way valve shown in FIG. 9 in action.

FIG. 11 illustrates different views of an inner ring in accordance with another preferred embodiment of the present invention, for installing internally to a conventional teat.

FIG. 12 illustrates different views of a one-way valve in a teat in accordance with yet another preferred embodiment of the present invention.

FIG. 13 illustrates the one-way valve shown in FIG. 12, in action.

FIG. 14 illustrates different views of a one-way valve in accordance with another preferred embodiment of the present invention.

FIG. 15 illustrates the one way valve shown in FIG. 14 installed in a standard bottle.

FIG. 16 illustrates the one-way valve shown in FIG. 15, in action.

FIG. 17 illustrates different views of a one-way valve in accordance with another preferred embodiment of the present invention, for installing in a regular feeding bottle and a regular teat.

FIG. 18 illustrates different views of a one-way valve in a teat of a bottle in accordance with yet another preferred embodiment of the present invention.

FIG. 19 illustrates the one-way valve shown in FIG. 17, in action.

FIG. 20 illustrates different views of a bottle adapted to receive a one-way valve in accordance with a preferred embodiment of the present invention.

FIG. 21 illustrates an inner ring for a bottle shown in FIG. 20 and in accordance with a preferred embodiment of the present invention.

FIG. 22 illustrates the inner ring shown in FIG. 21 installed in the bottle shown in FIG. 20 in accordance with a preferred embodiment of the present invention. FIG. 23 illustrates the one-way valve shown in FIG. 22, in action.

FIG. 24 illustrates different views of a one-way valve in a bottle in accordance with another preferred embodiment of the present invention.

FIG. 25 illustrates the one-way valve shown in FIG. 24 in action.

FIG. 26 illustrates different views of a bottle provided with a through hole and two bores in accordance with a preferred embodiment of the present invention.

FIG. 27 illustrates different views of an inner hole coverage in accordance with another preferred embodiment of the present invention, for installing internally to the teat shown in FIG. 26.

FIG. 28 illustrates different views of a one-way valve in a bottle in accordance with yet another preferred embodiment of the present invention.

FIG. 29 illustrates the one-way valve shown in FIG. 28, in action.

FIGS. 30 illustrate different views of modified bottle in accordance with yet another preferred embodiment of the present invention.

FIG. 31 illustrate different views of modified teat in accordance with yet another preferred embodiment of the present invention.

FIG. 32 illustrate different views of modified bottle and teat shown in FIGS. 30 and 31 assembled and at rest.

FIG. 33 illustrates different view of modified bottle and teat shown in FIG. 32 in action.

### DETAILED DESCRIPTION OF THE INVENTION AND THE FIGURES

The present invention provides a new and unique one-way valve for infant feeding bottles that is easy and simple to construct. Some embodiments of the present invention can be installed onto regular teats or regular bottles. In some of the embodiments, the teat or the bottle is slightly changed so as to be able to receive the one-way valve.

Basically, the one-way valve comprises a passageway in the feeding bottle and a relatively flexible wall that is installed adjacently to the passageway so as to cover the passage. The passageway and the flexible wall comprises a one-way valve that is alternating between a state in which there is aerodynamically communication between the exterior and the interior of the feeding bottle and a state in which the aerodynamic communication is prevented. In this way, air can be transferred through the passageway when a relative high pressure is presented on one side of the passageway by pushing the flexible wall away from the passage. If pressure is evolved on the side of the flexible wall, this wall is pushed even stronger toward the passageway, not allowing anything to pass through it.

The inventor of the present invention developed several embodiments based on this basic principle so as to form a one-way valve in a teat of infant feeding bottle. Those one-way valves avoid the formation of relative low pressure within the bottles and prevent health and sucking problems associated with feeding infants of feeding bottles.

The embodiments of the present invention are easy to construct and easy to clean.

In accordance with one aspect of the present invention, the one-way valve is installed in the teat of the bottle. For that reason, the teat is provided with a trough hole that will serve for transferring air from the exterior of the bottle to its inner part in order to compensate the low pressure that is form by the baby that sucks the food out of the bottle through the teat.

It should be mentioned that all figures are provided with three views: a side cross sectional view, a side view and an upper view. All the figures that illustrated the one-way valve in action are illustrative while showing the flow of air through the valve and in the gap formed between the hole and the flexible wall.

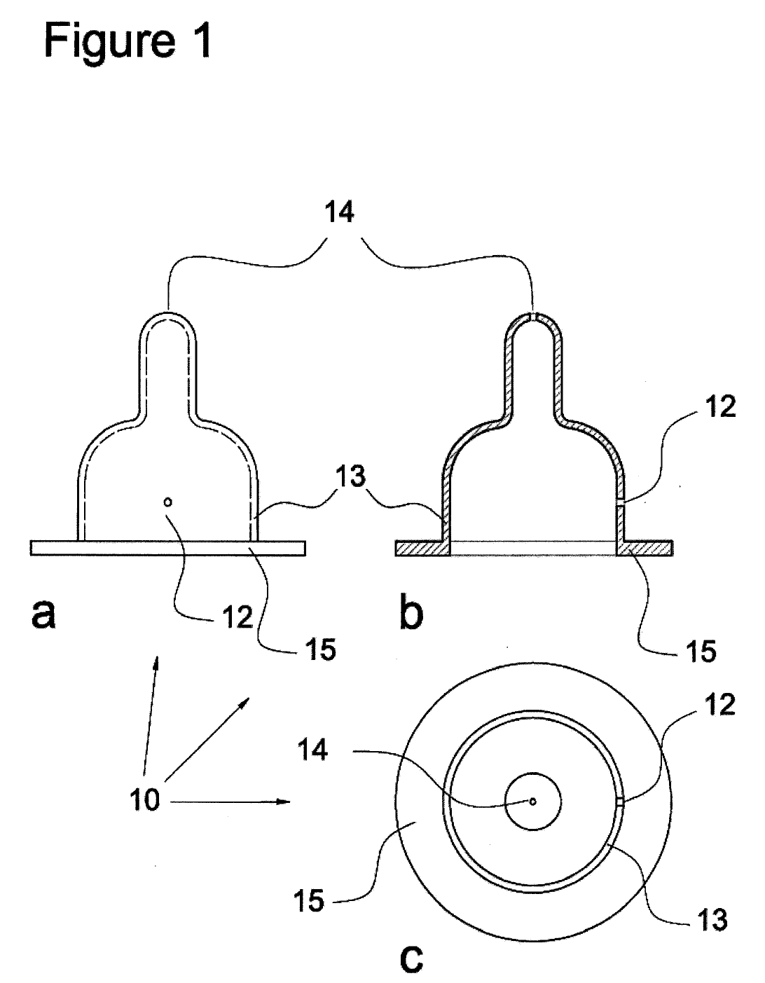

Reference is now made to FIG. 1 illustrating different views of a teat provided with a through hole in accordance with a preferred embodiment of the present invention. Generally, in most of the figures, three views are shown as follows: a—side view; b—side cross sectional view; and c—upper view. Teat 10 is provided with a through hole 12 drilled in its relatively straight wall 13 preferably in a relatively bottom portion of the teat. Through hole 12 is not adapted to be covered by the mouth of the infant that is sucking the food of the bottle through the regular drilled hole in the uppermost point 14 of the teat. A lateral circumferential base 15 is provided beneath straight wall 13.

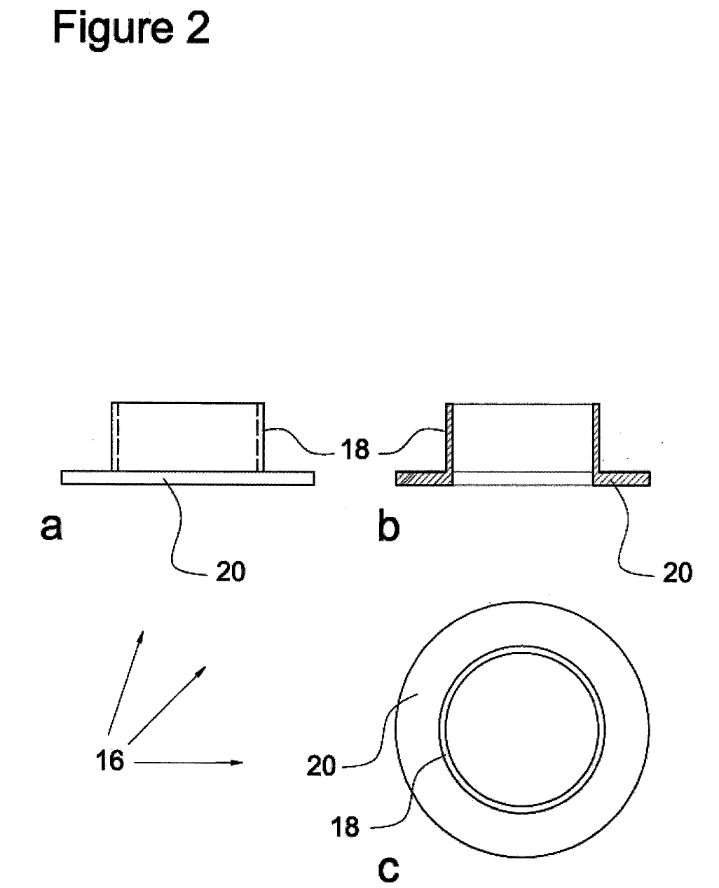

Reference is now made to FIG. 2 illustrating different views of an inner ring in accordance with a preferred embodiment of the present invention, for installing internally to the teat shown in FIG. 1. Inner ring 16 comprises a wall 18 adapted to internally and adjacently hold on to straight wall 13 of teat 10. A lateral circumferential base 20 is provided to wall 18.

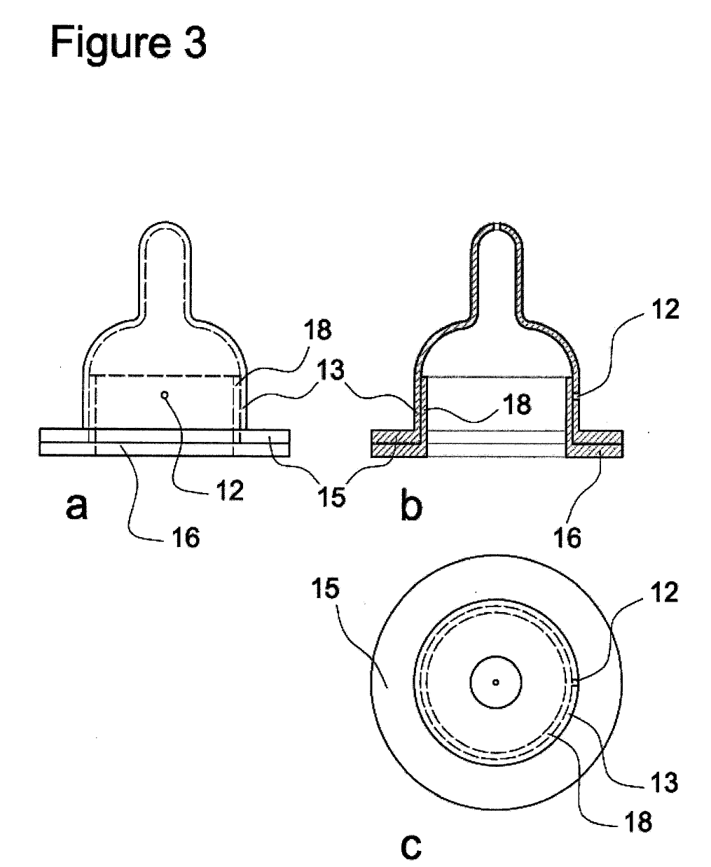

Reference is now made to FIG. 3 illustrating different views of a one-way valve in a teat in accordance with a preferred embodiment of the present invention. In order to form the one-way valve of the present invention, inner ring 16 is adjacently installed within teat 10 while wall 18 is covering through hole 12 to form the one-way valve.

The teat with the one way valve is installed on a bottle. Inner ring 16 is held in place and prevented from rotating within the teat by circumferential base 20 that is pressed between the teat and the bottle using a screw known in the art; in a manner similar to the teat itself that is firmly held in place by the screw (the screw is not shown in the figures).

It should be noted that a partial ring can be employed in the one way valve of the present invention without limiting the scope of the instant invention.

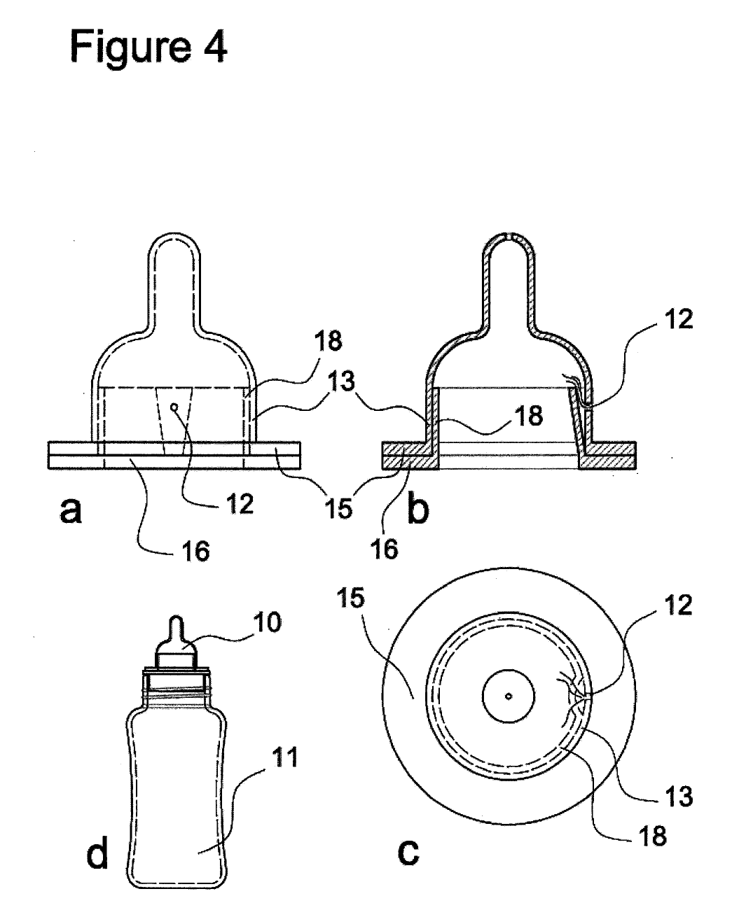

Reference is now made to FIG. 4 illustrating the one-way valve shown in FIG. 3 in action. When low pressure is evolved within teat 10 and eventually within the feeding bottle 11 that is a closed environment (shown in FIG. 4d) relative to the ambient pressure outside the bottle and the outer wall of the teat, wall 18 of the inner ring slightly move, allowing air to pass through hole 12 and enter the bottle onto which the teat is installed on in order to equalize the pressure within the bottle to the ambient pressure. Food from the interior of the bottle can not pass through hole 12 to its exterior due to fixation of wall 18 of inner ring 16 to hole 12 whenever pressure in the interior of the bottle equals or exceeds the ambient pressure. The hole and the adjacent wall form the one-way valve.

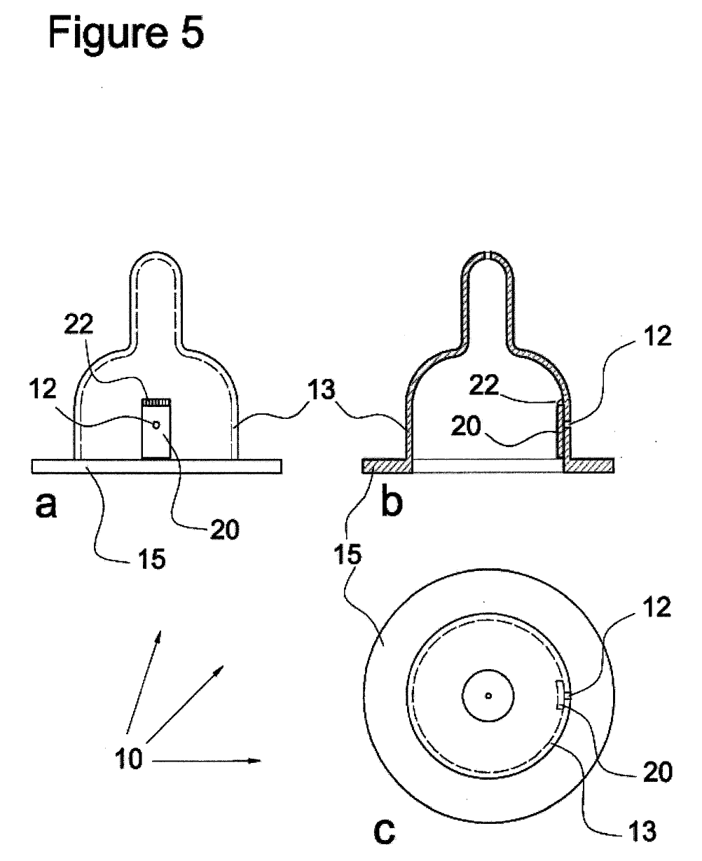

Reference is now made to FIG. 5 illustrating different views of a one-way valve in a teat in accordance with another preferred embodiment of the present invention. Teat 10 that is similar to the teat shown in FIG. 1, is provided with a flat member 20 partially soldered 22 to wall 13 in the vicinity of through hole 12 so that in a resting state, flat member 20 is covering through hole 12 from the internal side of the teat. Similarly to the embodiment shown in FIG. 3, flat member 20 is adapted to move from wall 13 when low pressure is formed within the teat and the bottle.

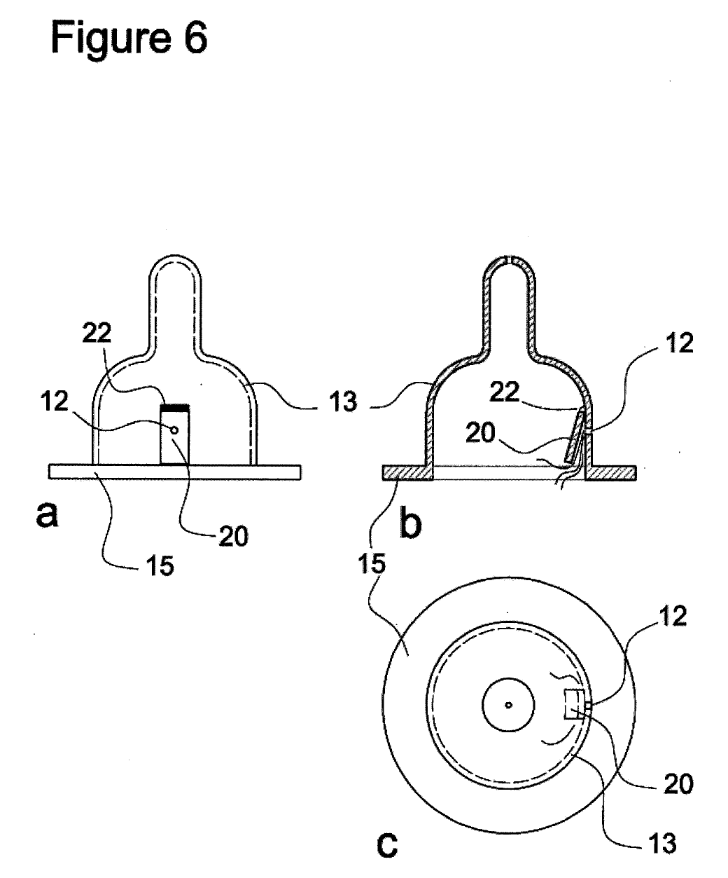

Reference is now made to FIG. 6 illustrating the one-way valve in action, wherein flat member 20 is moving allowing air to enter the bottle so as to equal the pressure between the interior of the bottle and the ambient pressure when a baby is sucking food out of the bottle. Soldered portion 22 is adapted to hold flat member 20 so that when the pressures are equalized, the member is adapted to cover hole 12 again.

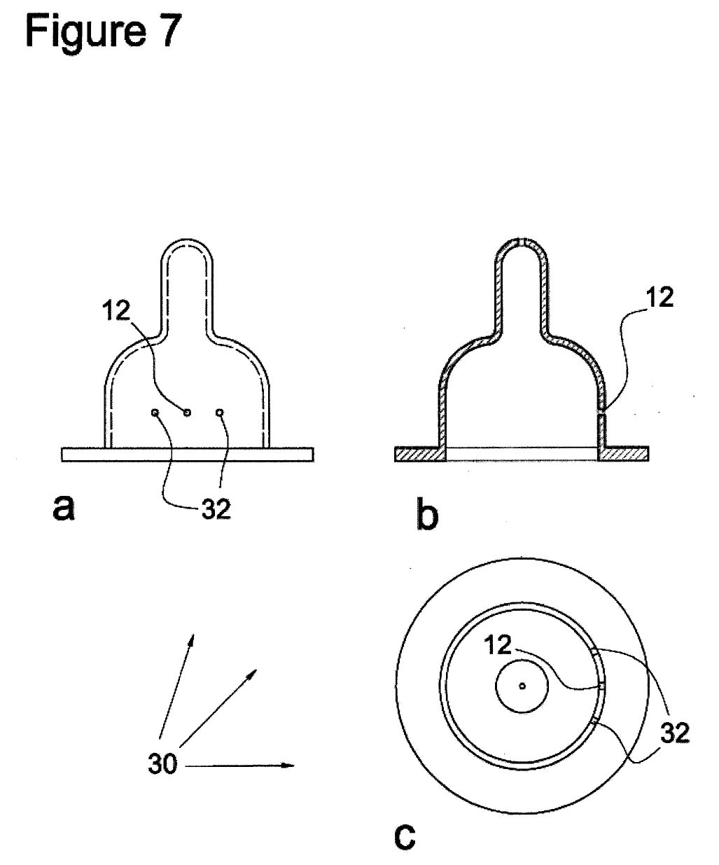

Reference is now made to FIG. 7 illustrating different views of a teat provided with a through hole and two bores in accordance with a preferred embodiment of the present invention. Teat 30 is provided with a through hole 12 drilled similarly to the hole in teat 10 and is provided with additional 2 bores 32 that can be preferably through holes or optionally, can be partial holes that do not totally pass through wall 13. Bores 32 are positioned preferably on both sides of hole 12.

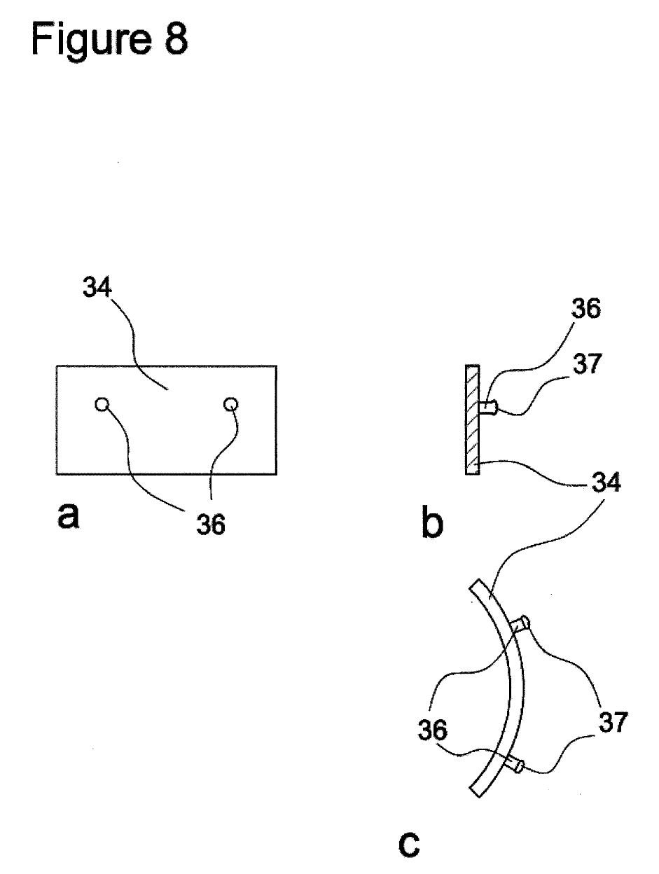

Reference is now made to FIG. 8 illustrating different views of an inner hole coverage in accordance with a preferred embodiment of the present invention, for installing internally to the teat shown in FIG. 7. Flat member 34 is shaped in a curved shape (shown in the upper view) so as to accord wall 13 of teat 30. Two protrusions 36 are provided pointing at one side of flat member 34 and are adapted to accord bores 32 in the teat. The free end of protrusion 36 is provided with a slight expansion 37. Flat member 34 is adapted to be installed adjacently to the interior of teat 30 so that the area between protrusions 36 will cover through hole 12.

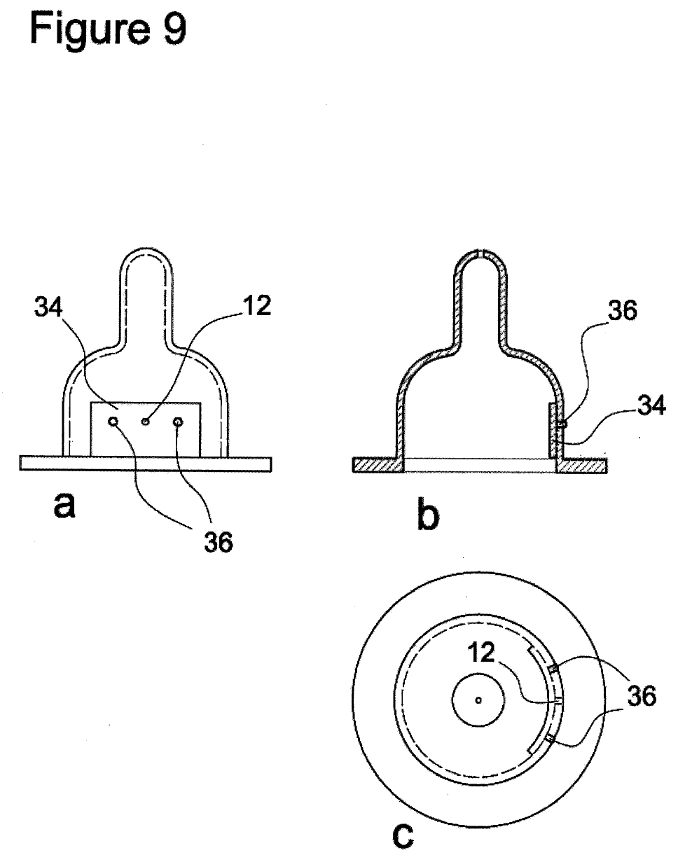

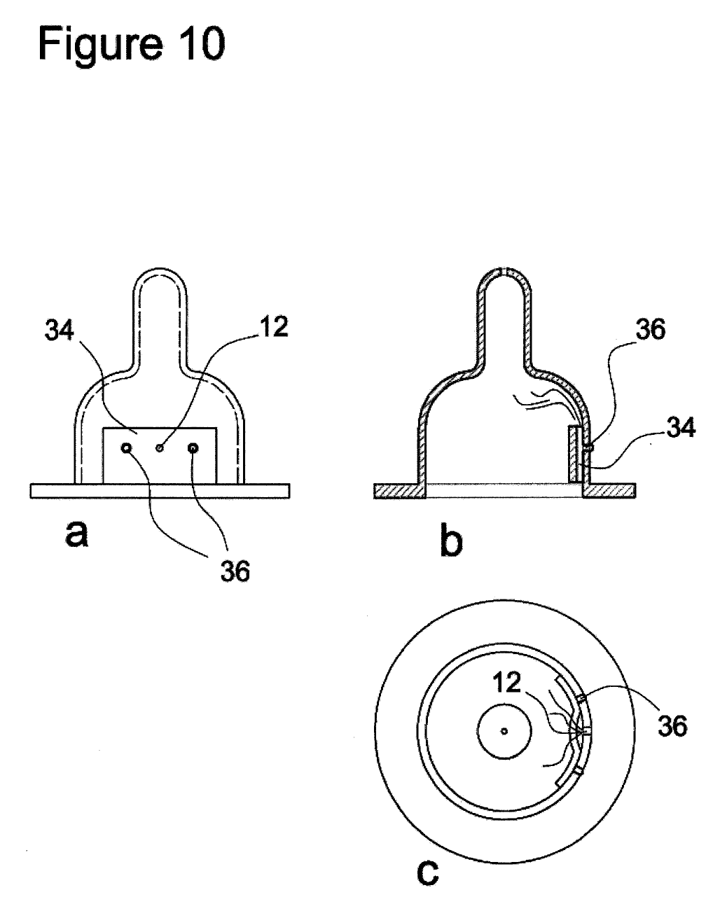

Reference is now made to FIGS. 9 and 10 illustrating different views of a one-way valve in a teat in accordance with yet another preferred embodiment of the present invention, in rest and in action, respectively. Protrusions 36 are pushed to within bores 32 so as to hold flat member 34 in place adjacent through hole 12 and to cover it when the one-way valve in at rest. The expansions of protrusions 36 are projecting of bores 32 so as to prevent possible separation of flat member 34 of the teat and dismantling the one way valve. When in action, protrusions 36 are still hooked within bores 32, but the centerpiece of flat member that covers hole 12 is slightly moving away from wall 34 in order to allow air to pass through hole 12 and enter the bottle.

It should be mentioned that two bores are given herein solely as an example. More than one bore and a corresponding protrusion can be provided to the flat member without limiting the scope of the present invention.

In addition, it should be noted that the protrusions can be provided in the teat rather than in the coverage and the holes in the coverage while this type of change as well as other amendments in the embodiment is covered by the scope of the present invention.

In another aspect of the present invention, a one-way valve can be formed without altering the teat or the bottle.

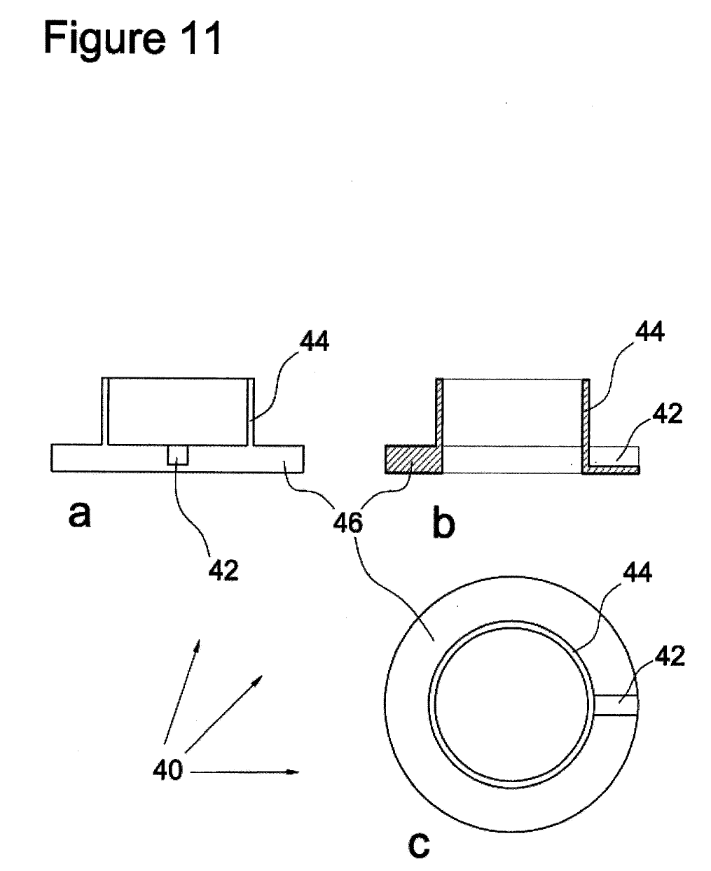

Reference is now made to FIG. 11 illustrating different views of an inner ring in accordance with another preferred embodiment of the present invention, for installing internally to a conventional teat. Inner ring 40 is adapted to accord the dimensions of a conventional teat so as to be installed internally within the teat and act as a one-way valve. Inner ring 40 is provided with a wall 44 adapted to be adjacent to the lower straight wall of the regular teat and a lateral circumferential base 46 adapted to be held adjacently to the base of the teat. Base 46 is provided with a passageway 42 that passes laterally through the base.

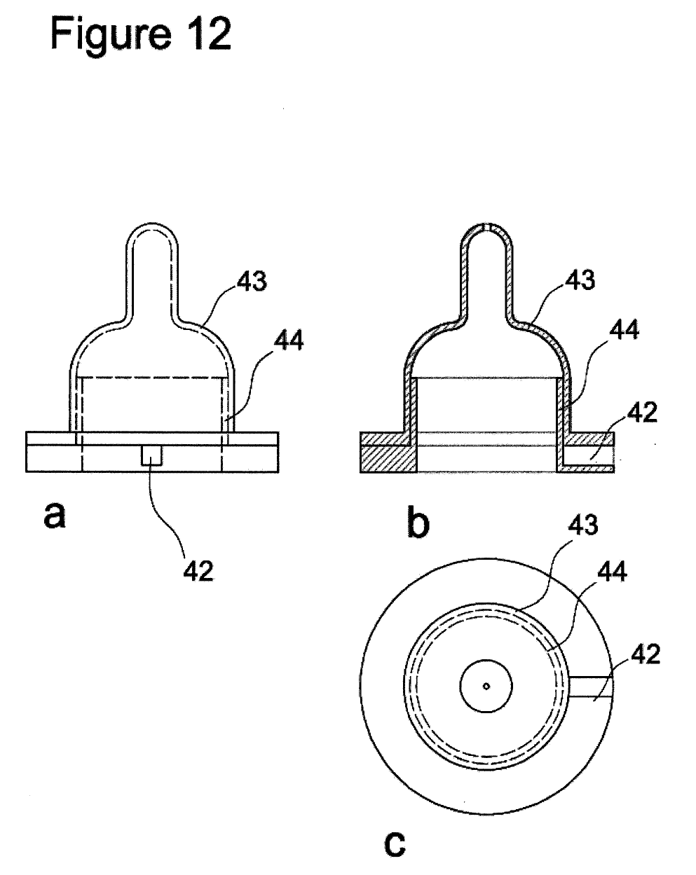

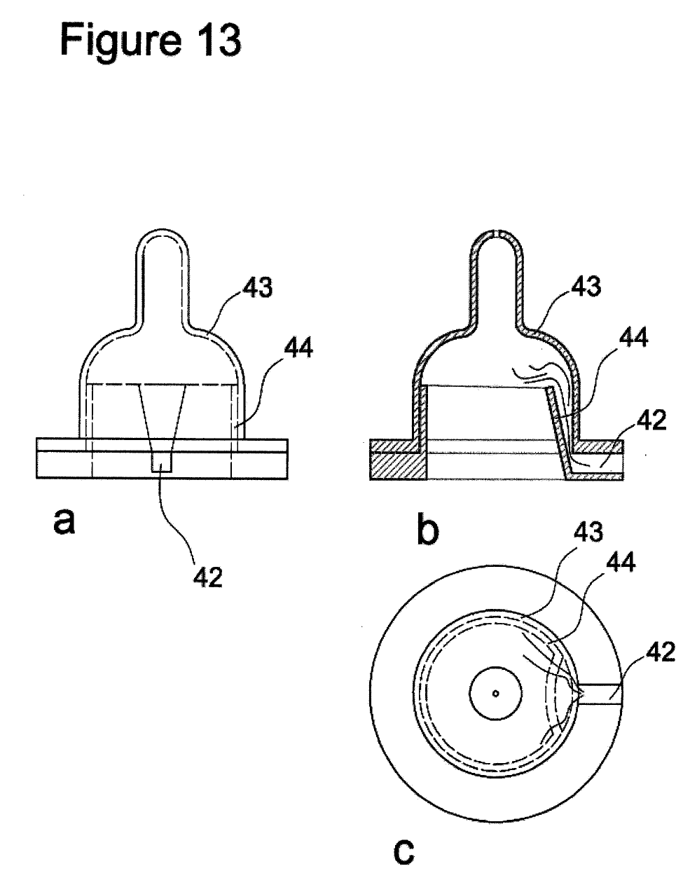

Reference is now made to FIGS. 12 and 13 illustrating different views of a one-way valve in a teat in accordance with yet another preferred embodiment of the present invention, at rest and in action, respectively. When the one-way valve is at rest, the two adjacent walls—wall 44 of inner ring 40 and the wall of a standard teat 43 form a closure upon passageway 42. When low pressure is formed within the bottle and the teat, air from the exterior of the bottle pushes wall 44 inwardly allowing air to pass through passageway 42 into the interior of the bottle.

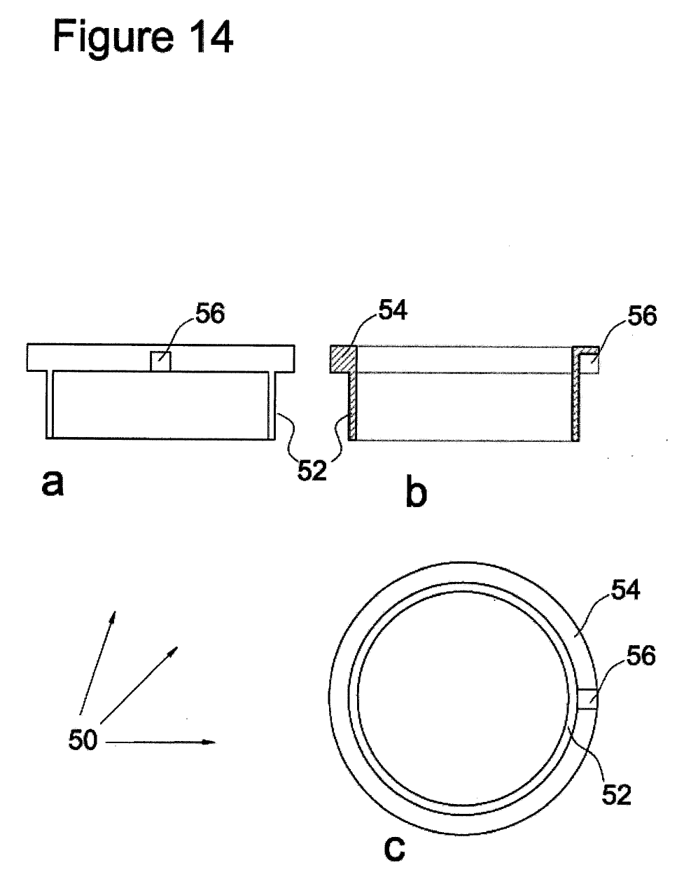

Reference is now made to FIG. 14 illustrating different views of a one-way valve in accordance with another preferred embodiment of the present invention. Inner ring 50 is similar in principle to inner ring 40; however, inner ring 50 is installed within the neck of a standard feeding bottle. Inner ring 50 is provided with a wall 52 adapted to be installed adjacently and internally to the bottles neck (as will be shown herein after) and a shoulder 54 adapted to be mounted on the opening of the bottle and hold the ring from falling to within the bottle. A passageway 56 is provided within shoulder 54 that passes from its exterior side to its interior side.

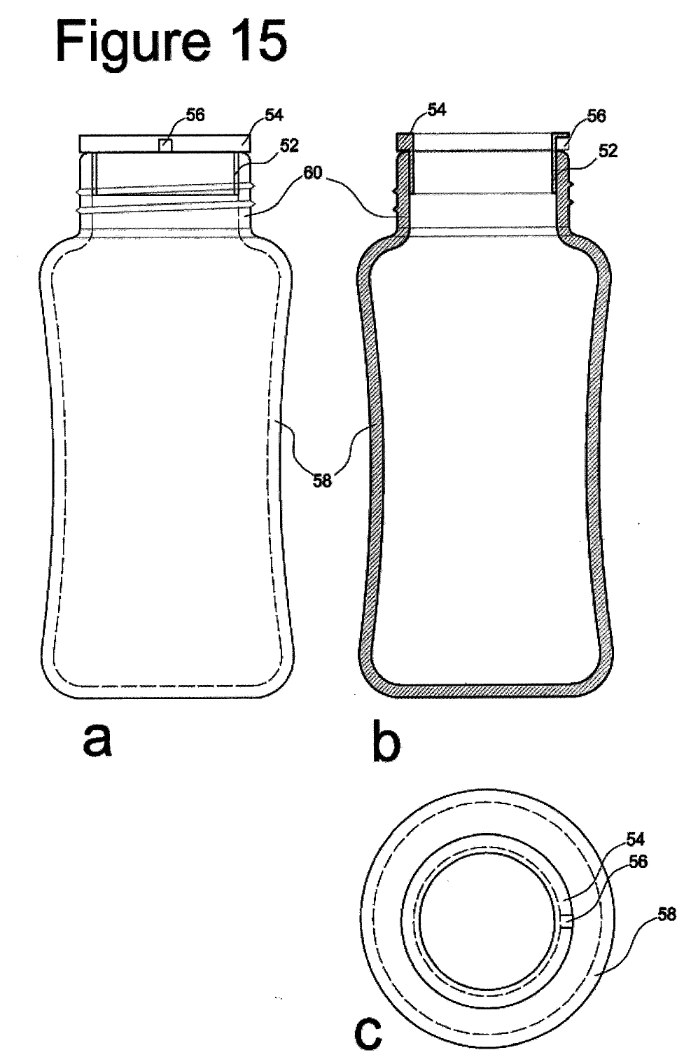

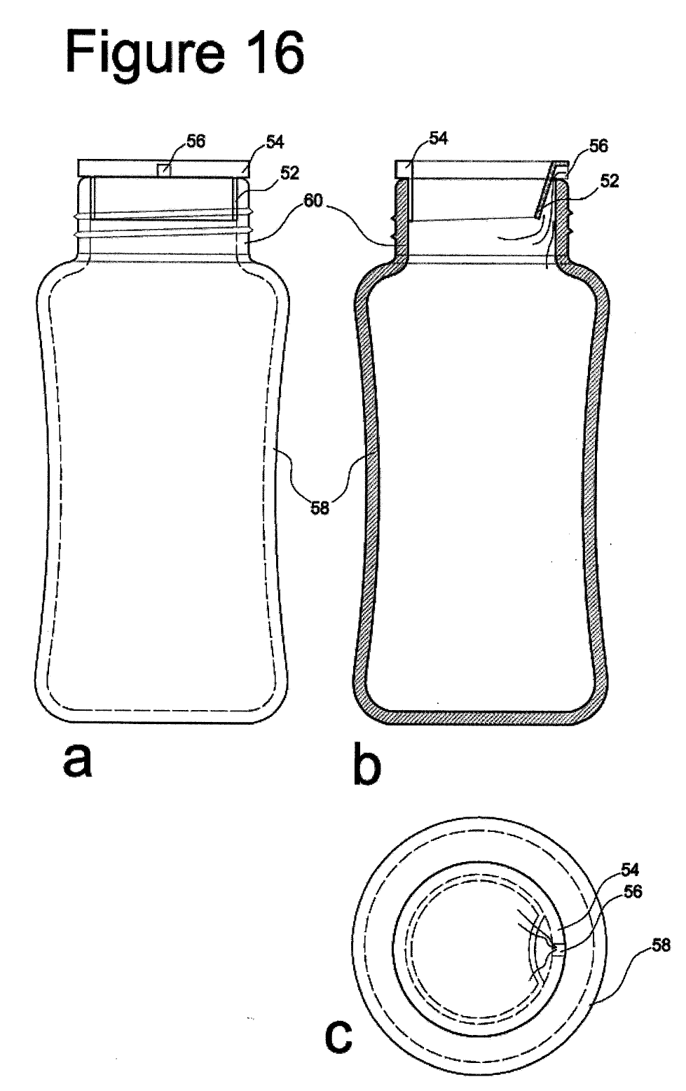

Reference is now made to FIGS. 15 and 16 illustrating the one way valve shown in FIG. 14 installed in a standard bottle, at rest and in action, respectively. At rest, wall 52 of inner ring 50 is adjacent a neck 60 of bottle 58. Shoulder 54 seats onto the opening of neck 60. As seen in the cross sectional views of FIG. 15, the two adjacent walls—wall 52 and neck 60—form a closure upon passageway 56, when at rest. In action as illustrated in FIG. 16, the ambient pressure pushes wall 52 of neck 60 so as to allow air to pass through passageway 56. It should be noted that the valve is operated when a teat that is not shown in FIGS. 15 and 16 is indeed screwed in a regular manner onto the neck of the bottle.

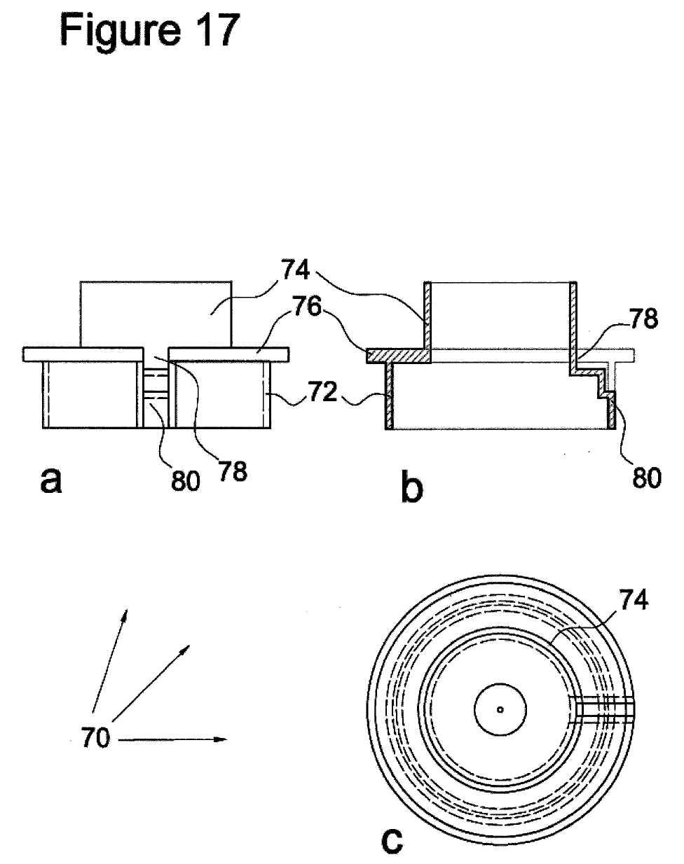

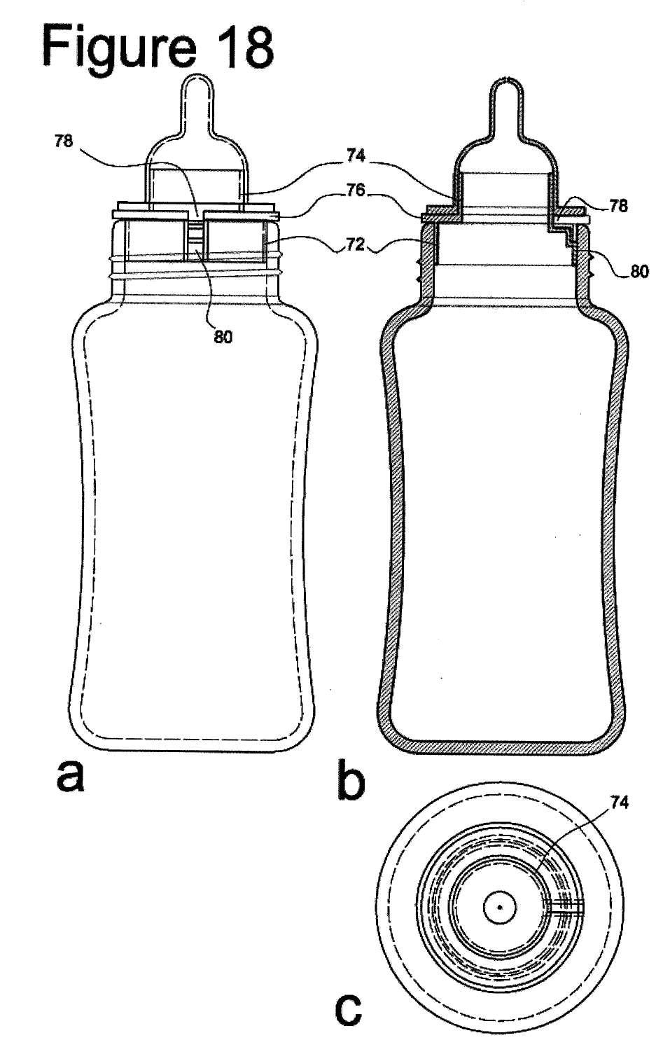

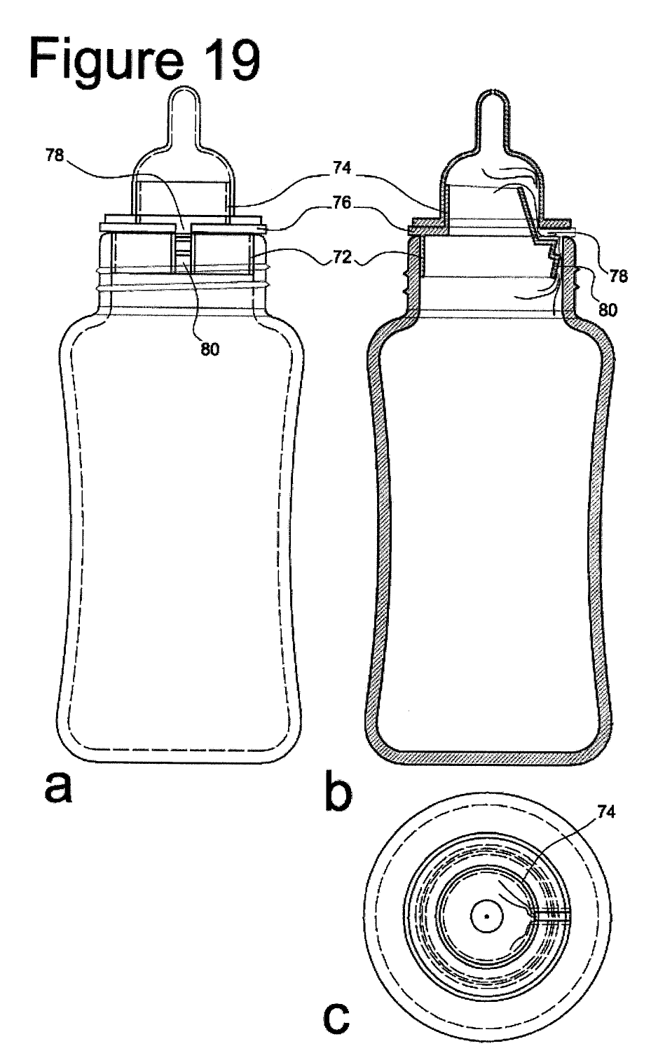

Reference is now made to FIGS. 17 to 19 illustrating different views of a one-way valve in accordance with another preferred embodiment of the present invention, for installing in a regular feeding bottle and a regular teat as well as installed in a feeding bottle provided with a teat, at rest and in action. Inner ring 70 combines the features that are presented in one-way valves shown in FIGS. 11 and 14. Inner ring 70 comprises a bottom wall 72 adapted to be internally adjacent to the neck of a standard bottle (58) and an upper wall 74 adapted to be positioned internally adjacent the wall of a standard teat. A shoulder 76 is provided between upper wall 74 and bottom wall 72. Two possible passageways are formed by producing a stepwise wall 78 and 80 in bottom wall 72. In FIG. 19 that shows the one way valve in action, it is seen that air can by transferred through the passageways either towards the teat or towards the bottle.

In yet another aspect of the present invention, the bottle is slightly altered while the teat is a standard teat without any changes.

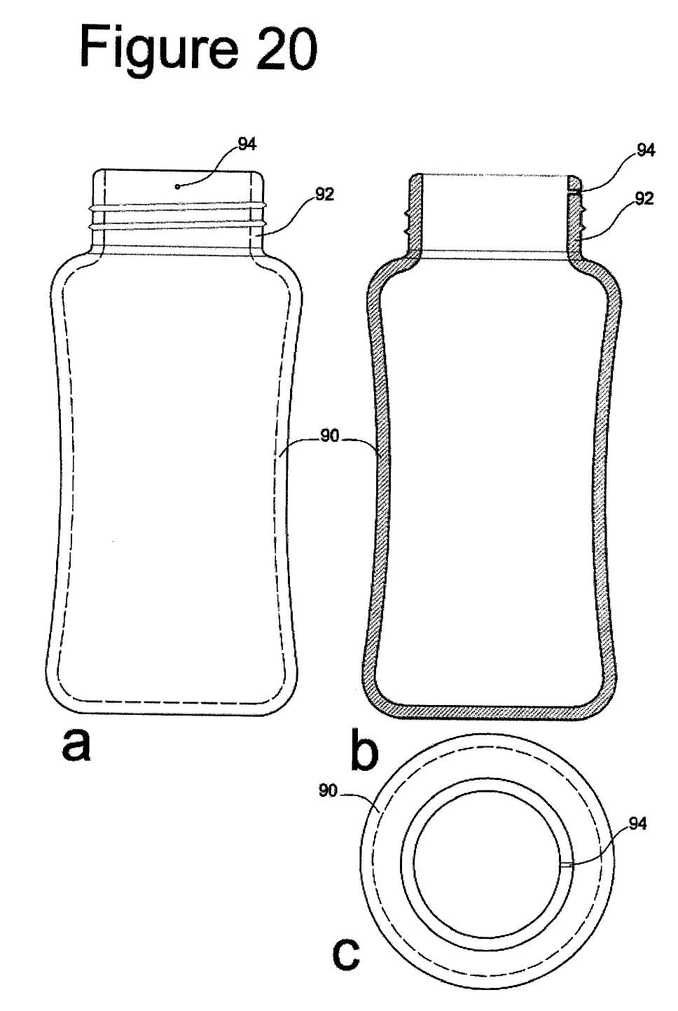

Reference is now made to FIG. 20 illustrating different views of a bottle adapted to receive a one-way valve in accordance with a preferred embodiment of the present invention. Bottle 90 provided with a neck 92 is provided with a drilled through hole 94 in its neck.

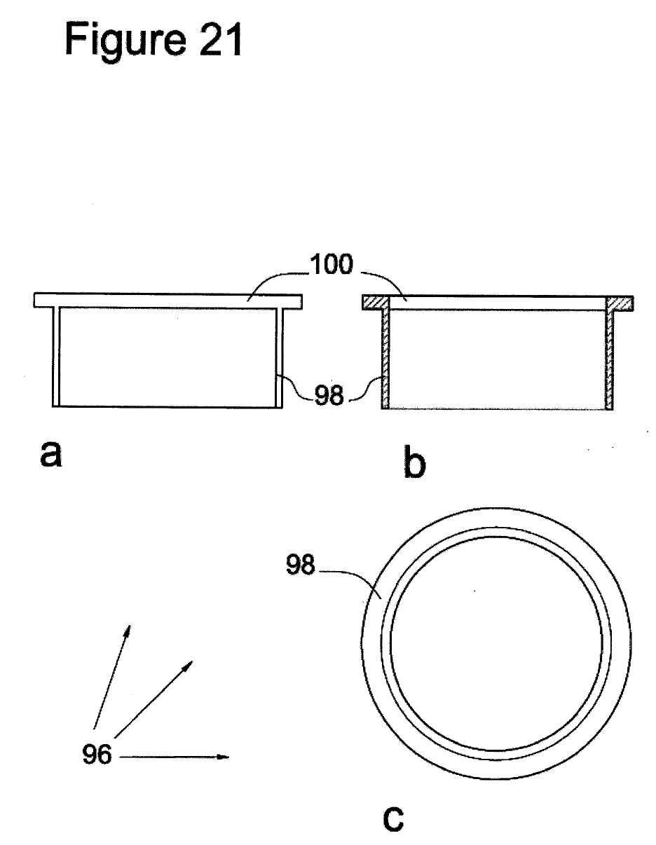

Reference is now made to FIG. 21 illustrating an inner ring for a bottle shown in FIG. 20 and in accordance with a preferred embodiment of the present invention. Inner ring 96 is adapted to be installed in neck 92 of bottle 90 and comprises a wall 98 that establishes a member that will be internally and adjacently installed within the neck of the bottle and a shoulder 100 adapted to seat on the opening of the bottles neck so as to prevent inner ring 96 from falling to within the bottle.

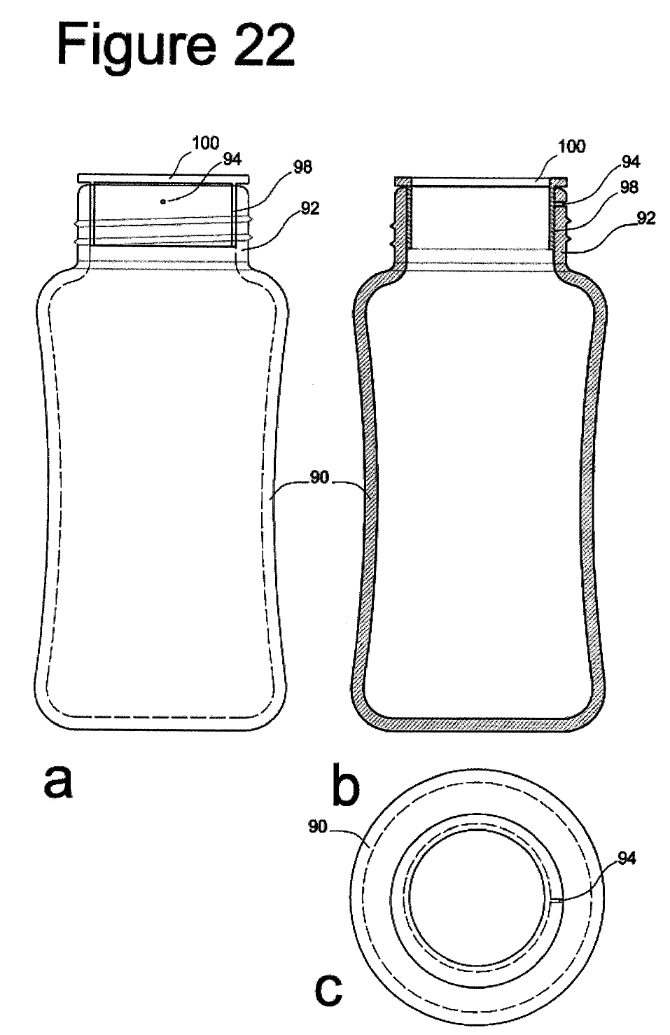

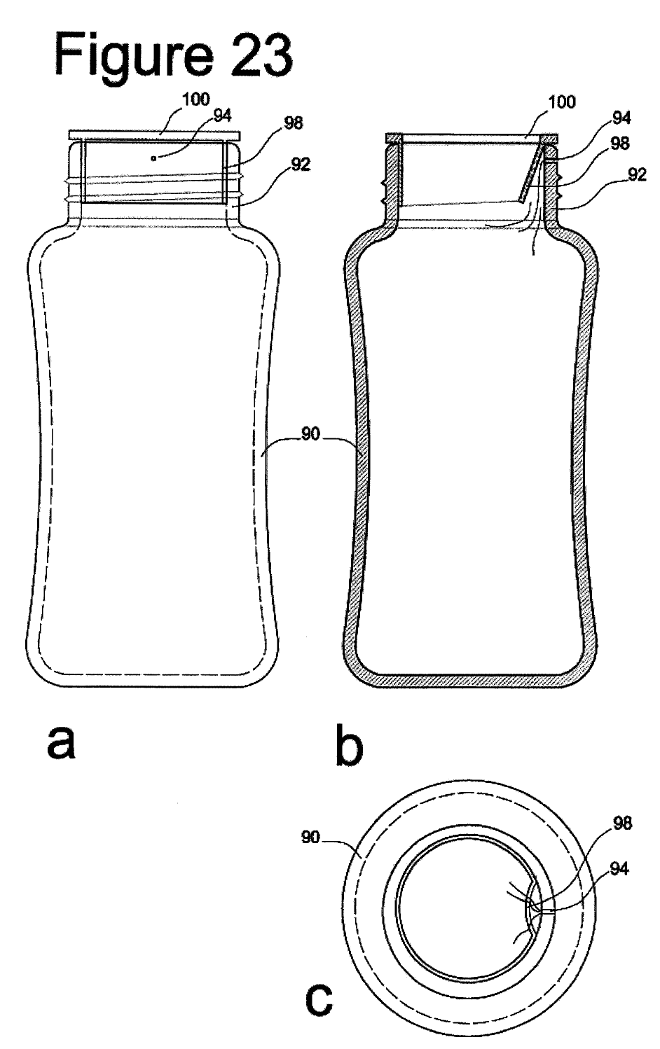

Reference is now made to FIGS. 22 and 23 illustrating the inner ring shown in FIG. 21 installed in the bottle shown in FIG. 20 in accordance with a preferred embodiment of the present invention, at rest and in action, respectively. Inner ring 96 is internally installed within neck 92 of the bottle so that wall 98 of the inner ring is covering through hole 94 in the neck of the bottle. At rest or even when the pressure in the interior of the bottle is higher than the ambient pressure, wall 98 is covering hole 94 so as to prevent air or food from passing through the hole. When the ambient pressure is higher than the pressure within the bottle, air is pushed through hole 94 while pushing also wall 98 away from neck 92, and as explained herein before.

It should be noted that inner ring 96 can be incorporated within a standard teat so as to establish one unit instead of two.

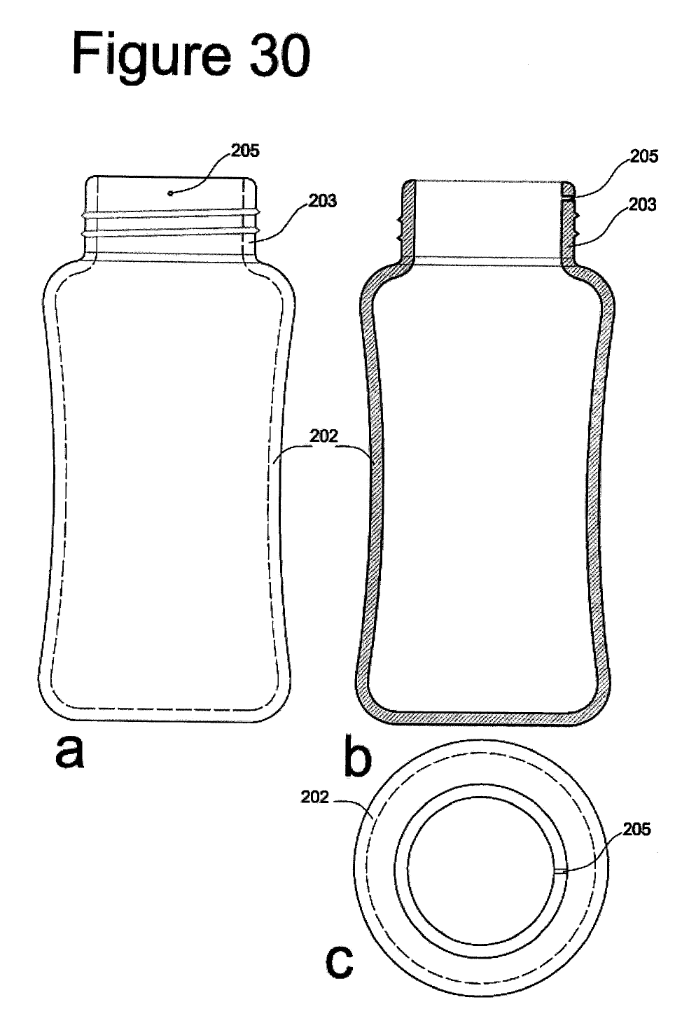

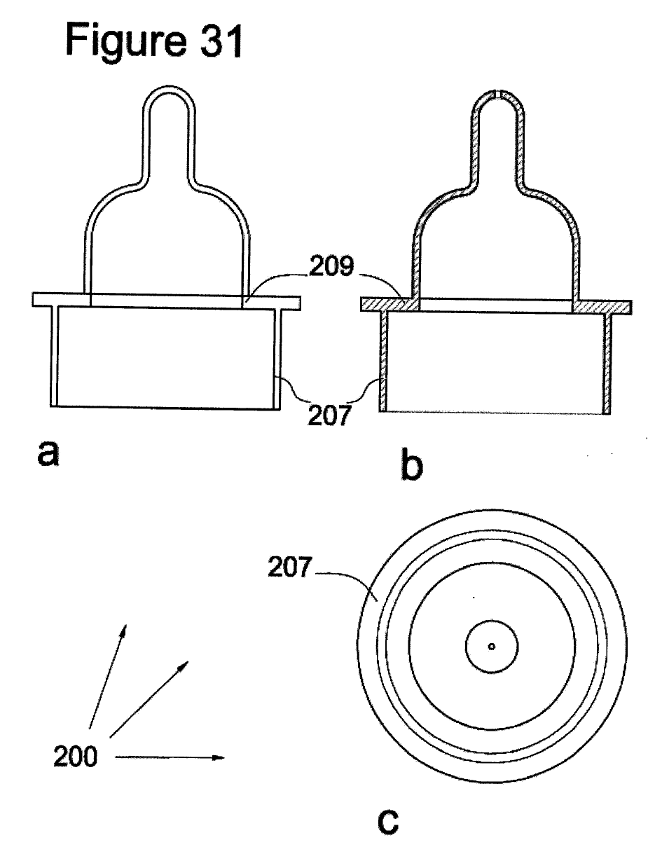

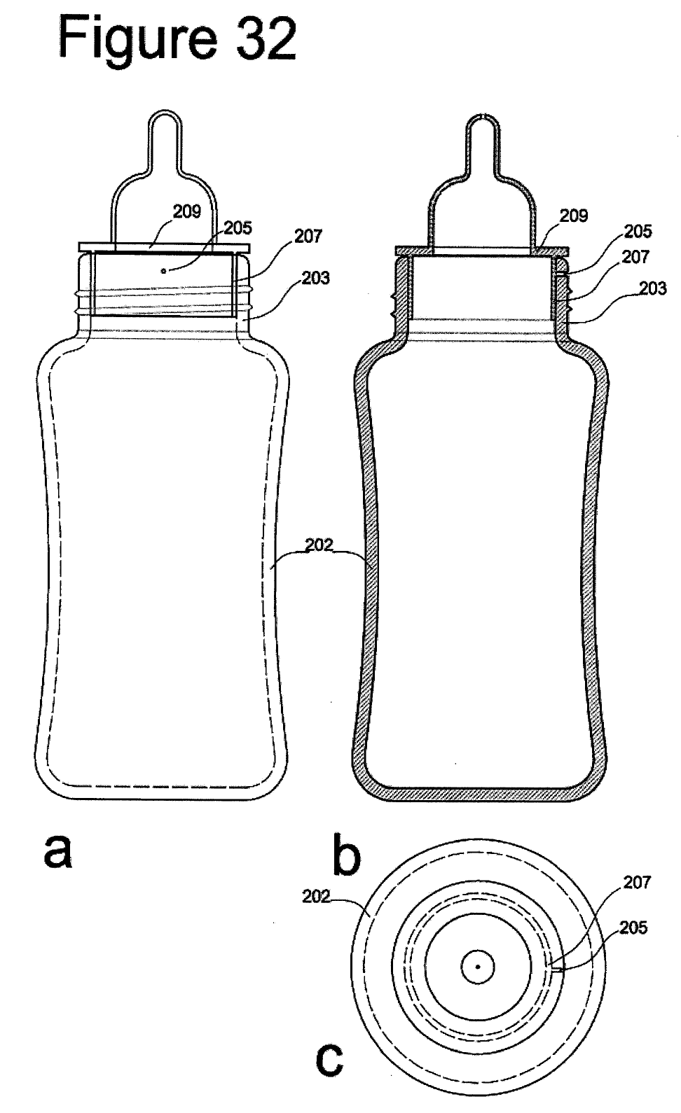

Reference is now made to FIGS. 30-33 illustrating several views of modified bottle and a teat in accordance with a yet another preferred embodiment of the present invention, disassembled, assembled, at rest and in action. FIG. 30 illustrates a bottle 202 provided with a passageway 205 in its neck 203. A corresponding teat 200 is depicted in FIG. 31 wherein shoulder 209 of teat 200 is incorporated with a lower coverage and preferably a ring 207. In this case, shoulder 209 is the acting as the base of the standard teat that is enclosed on the neck of the bottle. FIG. 32 illustrates teat 200 mounted on bottle 202 wherein shoulder 209 seats on the edge of neck 203 and ring 207 is inserted to within the neck, adjacent to it to form the one way valve.

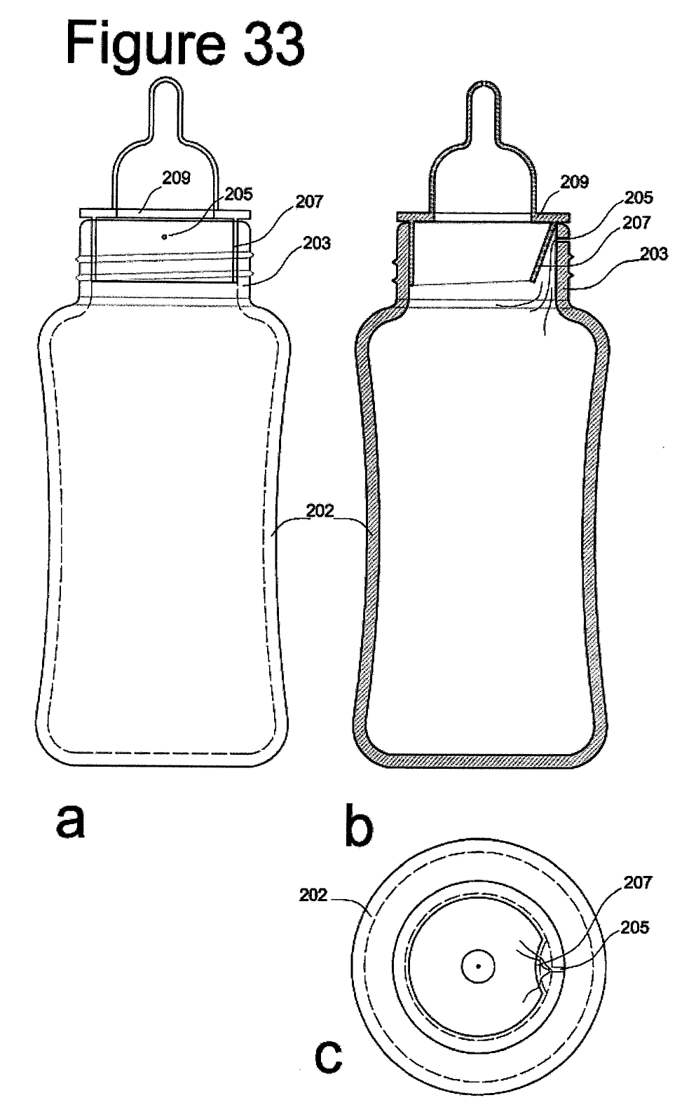

The one-way valve in action is shown in FIG. 33 in which ring 207 is shown to slightly move away from neck 203. This occurs, as previously explained, when the baby is sucking the food from the bottle forming low pressure within the bottle. The ambient pressure outside the bottle forces ring 207 to slightly move off neck 203 so that the pressure is equalized.

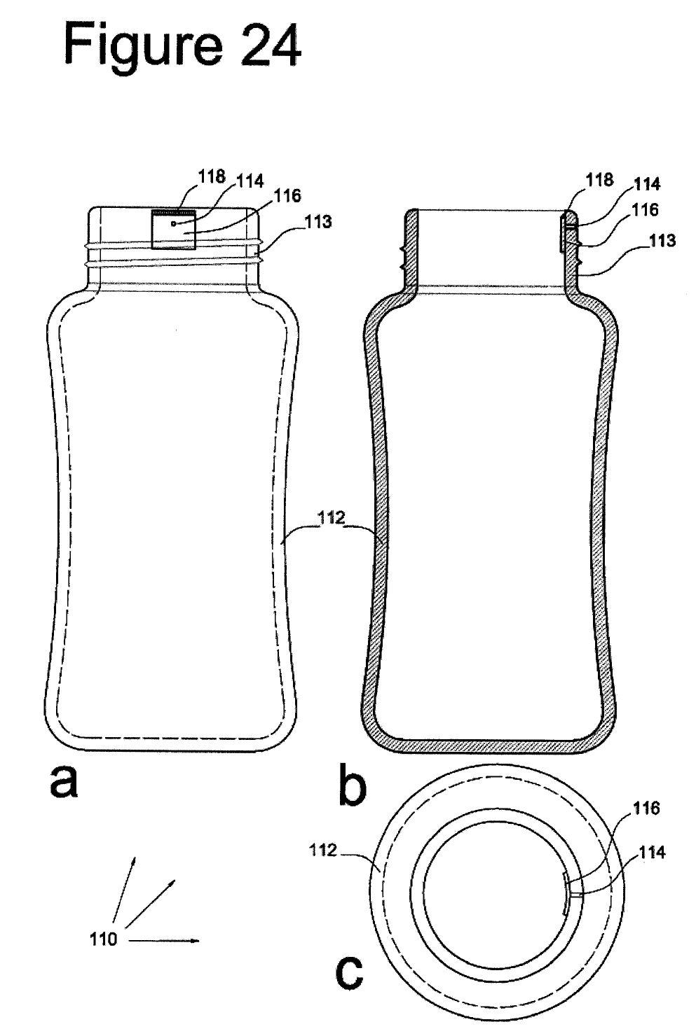

Reference is now made to FIG. 24 illustrating different views of a one-way valve in a bottle in accordance with another preferred embodiment of the present invention. Bottle 110 is provided with one-way valve in its neck area 113. One-way valve comprises a drilled hole 114 in neck area 113 and a flat member 116 that is soldered to the neck in a soldered portion 118 preferably on top of hole 114. The other portion of member 116 is free to cover hole 114.

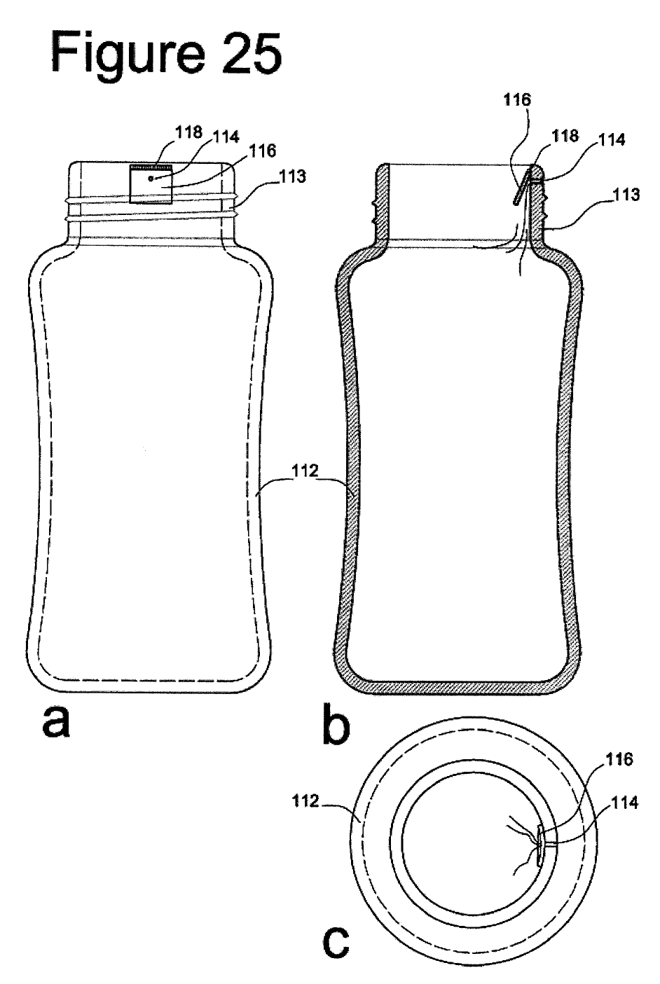

Reference is now made to FIG. 25 illustrating the one-way valve shown in FIG. 24, in action. Due to sucking food out of the bottle by the baby and relatively high pressure outside the bottle, air is entering the bottle by pushing flat member 116 slightly off hole 114.

It should be noted that the drilled hole can be positioned in any of the side walls of the bottle rather than the neck area.

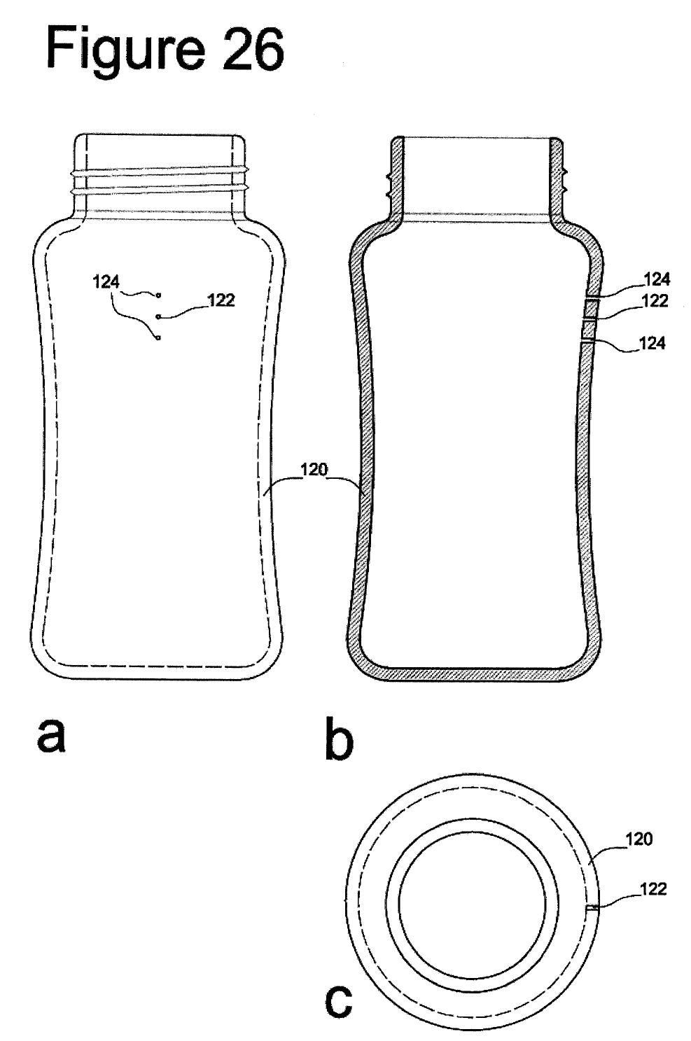

Reference is now made to FIG. 26 illustrating different views of a bottle provided with a through hole and two bores in accordance with a preferred embodiment of the present invention. Bottle 120 is provided with a through hole 122 on its side and two adjacently positioned bores 124. It should be noted that the bores are not necessarily through holes and can be partial bores as discussed herein before.

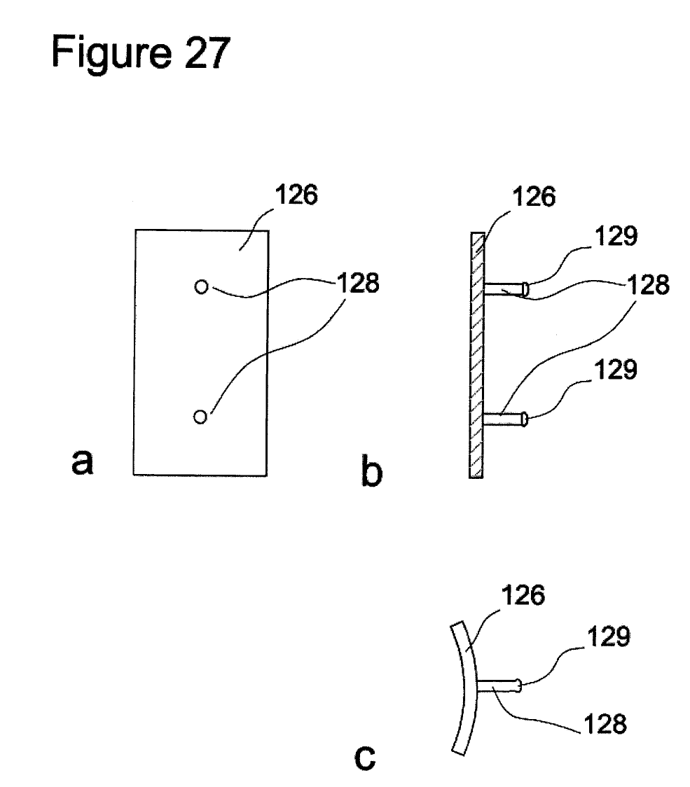

Reference is now made to FIG. 27 illustrating different views of an inner hole coverage in accordance with another preferred embodiment of the present invention, for installing internally to the teat shown in FIG. 26. Flat member 126 is curved so as to accord the inner curvature of bottle 120 and to especially conform the area of the drilled hole and bores. Member 126 is provided with two protrusions 128 that are adapted to fit in bores 124. Protrusions 128 are provided with expansions 129 at the free end as explained herein before.

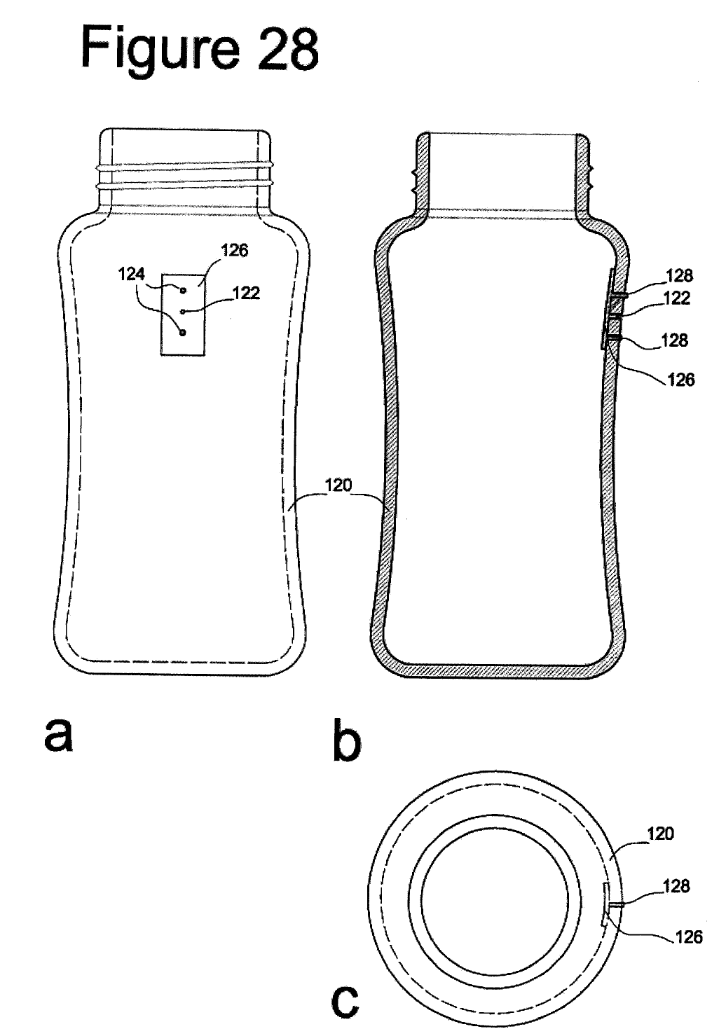

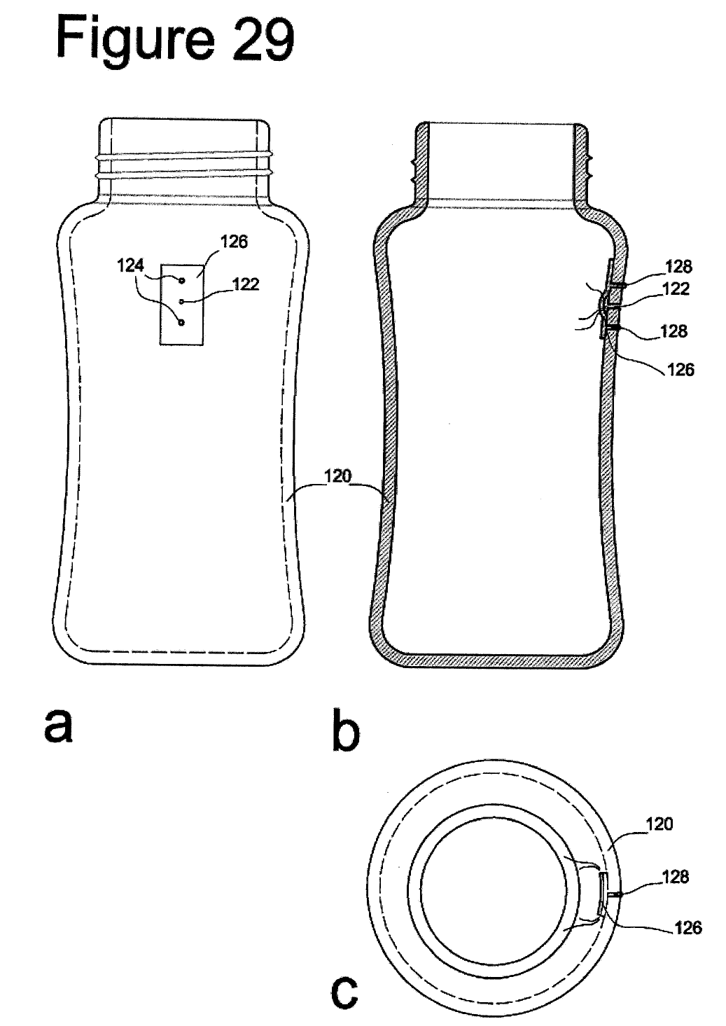

Reference is now made to FIGS. 28 and 29 illustrating different views of a one-way valve in a bottle in accordance with yet another preferred embodiment of the present invention, at rest and in action. FIG. 28 illustrate the one-way valve installed within the bottle. Flat member 126 is held adjacent and covering hole 122 by protrusions 128 and expansions 129 that are being inserted to within bores 124. When low pressure is formed within the bottle, air passes through hole 122 by pushing flat member 126 away from the wall of the bottle, as shown in FIG. 29.

It should be noted here as well that the protrusions can be provided in the bottle rather than in the coverage and the holes in the coverage while this type of change as well as other amendments in the embodiment is covered by the scope of the present invention.

It should be noted that the solutions provided herein are all adapted to different sizes and shapes of infant feeding bottles.

It should be noted that in the shown embodiments, the teat and the bottle are connected tightly together by a screw as known in the art.

It should be mentioned that more than one passageway can be provided in the teat or the bottle so as to increase the flow of air in order to equalize the inside and outside pressures.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A one-way valve for an infant feeding bottle having a teat and a bottle's body comprising:
At least one passageway aerodynamically communicating an interior of the feeding bottle and its exterior;
At least one member adapted to cover said at least one passageway wherein said at least one member is adapted to have a first position in which the member is fully adjacent to the passageway preventing the aerodynamic communication through the passageway and a second position in which the member is slightly removed of the passageway allowing air to pass through said at least one passageway; whereby when ambient pressure is higher than the pressure within the feeding bottle, the member is in its second position allowing passage of air through the passageway into the feeding bottle.

2. The valve as claimed in claim 1, wherein said at least one passageway is provided in the feeding bottle.

3. The valve as claimed in claim 2, wherein said at least one member is a circumferential ring adapted to fit an inner circumference of the feeding bottle in a vicinity of the passageway.

4. The valve as claimed in claim 3, wherein said at least one passageway is provided in the teat.

5. The valve as claimed in claim 3, wherein said at least one passageway is provided in the bottle's body.

6. The valve as claimed in claim 3, wherein said circumferential ring is held in place by a lateral base adapted to be pressed between the teat and the bottle's body.

7. The valve as claimed in claim 6, wherein said lateral base is incorporated within the teat.

8. The valve as claimed in claim 5, wherein said member is a flat member having protrusions designed to be inserted and maintained within respective holes in the teat.

9. The valve as claimed in claim 6, wherein at least one member is a flat member having protrusions designed to be inserted and maintained within respective holes in the bottle's body.

10. The valve as claimed in claim 2, wherein said member is a flat member soldered adjacent to said at least one passageway.

11. The valve as claimed in claim 1, wherein said member is a circumferential ring adapted to accord an inner circumference of the feeding bottle and wherein said passageway is provided in said circumferential ring.

12. The valve as claimed in claim 11, wherein said circumferential ring is provided with a lateral base in which said at least one passageway is provided and wherein said lateral base is adjacent to a lateral base of the teat.

13. The valve as claimed in claim 12, wherein said circumferential ring fits inner circumference of the teat.

14. The valve as claimed in claim 12, wherein said circumferential ring accord inner circumference of a neck area in the bottle's body.

15. The valve as claimed in claim 12, wherein said circumferential ring comprises an upper wall provided on one side of said lateral base and a bottom wall provided on the other side of said lateral base and wherein said upper wall accord inner circumference of the teat and said bottom wall accord inner circumference of a neck area in the bottle's body.

16. A method of forming a one-way valve in a feeding bottle comprising a teat and a bottle's body comprising:
providing at least one member capable of adjacently hold on an inner surface in the feeding bottle;
forming at least one passageway aerodynamically communicating an interior of the feeding bottle and its exterior;
placing said at least one member within the feeding bottle adjacent to said at least one passageway so that the passageway is regularly blocked and is allowing air flow when ambient pressure in the exterior of the feeding bottle exceeds pressure within the feeding bottle.

17. The method as claimed in claims 16, wherein said at least one passageway is in the teat.

18. The method as claimed in claim 16, wherein said at least one passageway is in the bottle's body.

19. The method as claimed in claim 16, wherein said member is a circumferential ring capable of fitting an inner circumference of the feeding bottle.

20. The method as claimed in claim 19, wherein said circumferential ring is provided with a lateral base adapted to be held between the teat and the bottle's body so as to maintain the ring in place.

21. The method as claimed in claim 16, wherein said at least one member is a flat member soldered to the feeding bottle in the vicinity of said the passageway.

22. The method as claimed in claim 16, wherein said at least one member is held adjacent to said the passageway by protrusions that are inserted in dedicated bores in the feeding bottle.

23. A method of forming a one-way valve in a feeding bottle comprising a teat and a bottle's body comprising:
providing at least one member having a passageway;
placing the member so that an interior of the feeding bottle is aerodynamically communicating with its exterior wherein the passageway is regularly blocked by the feeding bottle and allows air flow when ambient pressure outside the feeding bottle exceeds pressure within the feeding bottle.

24. The method as claimed in claim 23, wherein said at least one member is a circumferential ring having a lateral base designed to sit between the teat and the bottle's body and wherein said passageway is provided in said lateral base.
